(19) United States
(12) Patent Application Publication
(10) Pub. No.: US 2020/0271885 A1
(43) Pub. Date: Aug. 27, 2020

(54) LENS MODULE AND ELECTRONIC DEVICE USING THE LENS MODULE

(71) Applicant: TRIPLE WIN TECHNOLOGY(SHENZHEN) CO.LTD., Shenzhen (CN)

(72) Inventors: KUN LI, Shenzhen (CN); SHIN-WEN CHEN, Tu-Cheng (TW); LONG-FEI ZHANG, Shenzhen (CN); XIAO-MEI MA, Shenzhen (CN)

(21) Appl. No.: 16/503,712

(22) Filed: Jul. 5, 2019

(30) Foreign Application Priority Data
Feb. 27, 2019 (CN) 201920250066.4

(51) Int. Cl. G02B 7/02

(52) U.S. Cl. CPC G02B 7/022

(57) ABSTRACT

A robust and repairable lens module adaptable in size and height for different electronic devices includes a lens holder and a lens unit. The lens holder and the lens unit are both detachable. The lens holder defines a receiving hole with double threads to mount the lens unit in the receiving hole. A gap exists between the threads to allow equalization of pressure in the lens module with ambient air pressure. An electronic device applying such a lens module is also provided.

### FIELD

The subject matter herein generally relates to imaging devices.

### BACKGROUND

A lens module in most mobile phones generally include a lens unit, a filter, a sensor chip, a bracket, and a circuit board. The lens unit generally includes a lens holder and lenses integrated with the lens holder.

However, the fabricating of the lens unit can be achieved only with the AA process, other processes such as the LHA process cannot be employed. Secondly, the lens unit cannot be taken out for repair. If the lens unit has quality problems, the whole lens module needs to be replaced. Thirdly, the lens module is not adjustable in height to meet different mechanical height requirements of different applications. Fourthly, walls of the lens module are thin and the lens module is fragile, not robust. Fifthly, when the lens module is heated during operation, expanded air cannot escape, which may cause tilting and poor images.

Therefore, there is room for improvement.

### BRIEF DESCRIPTION OF THE DRAWINGS

Implementations of the present technology will now be described, by way of embodiments, with reference to the attached figures.

FIG. 1 is an isometric view of a lens module according to an embodiment of the present disclosure.

FIG. 2 is an exploded view of the lens module of FIG. 1.

FIG. 3 is a cross-sectional view of the lens module of FIG. 1 taken along line of FIG. 1.

FIG. 4 is a perspective view of an electronic device using the lens module of FIG. 1 according to an embodiment of the present disclosure.

### DETAILED DESCRIPTION

The present disclosure is made in conjunction with the accompanying drawings. Specific embodiments of the present disclosure are described.

In the following description, when an element is described as being “fixed to” another element, the element can be fixed to the another element with or without intermediate elements. When an element is described as “connecting” another element, the element can be connected to the other element with or without intermediate elements.

Without a given definition otherwise, all terms used have the same meaning as commonly understood by those skilled in the art. The term “and/or” means including any and all combinations of one or more of associated listed items.

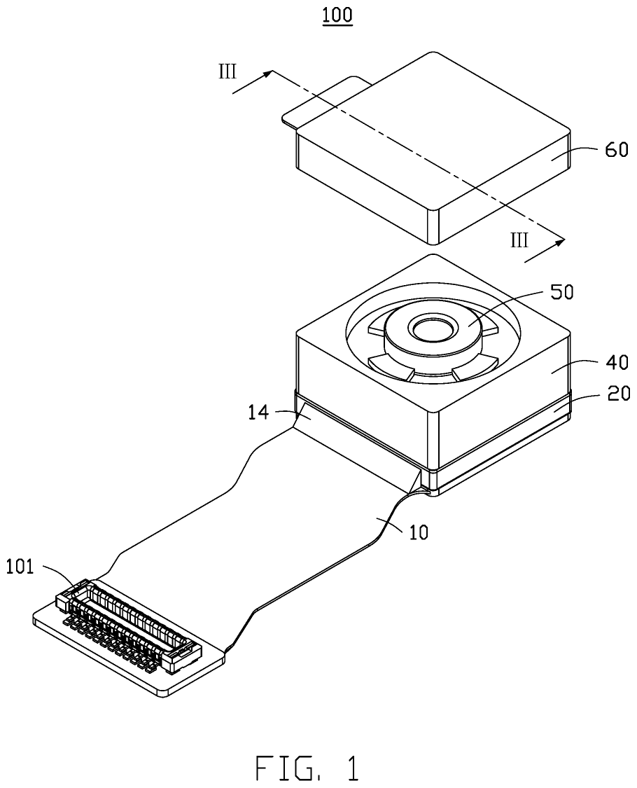

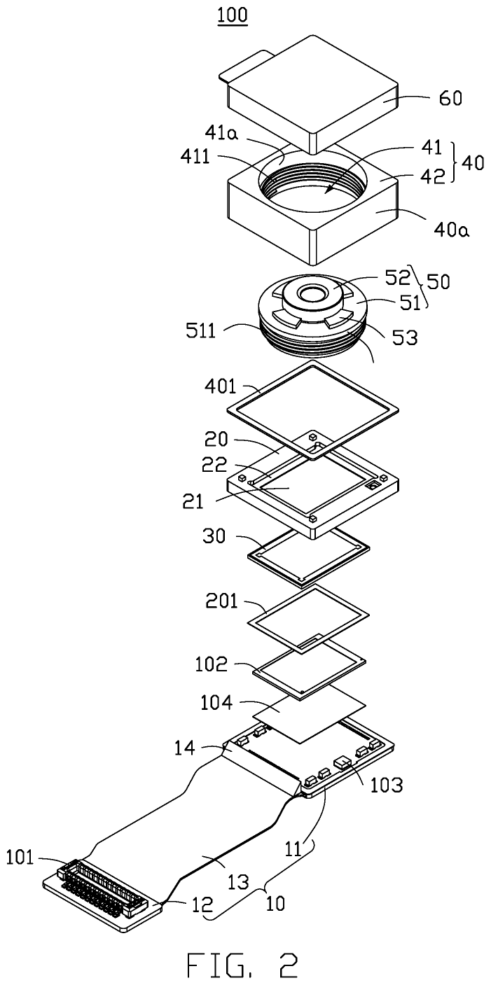

Referring to FIG. 1 and FIG. 2, an embodiment of the present disclosure provides a lens module 100. The lens module 100 includes a circuit board 10, a bracket 20, a filter 30, a lens holder 40, a lens unit 50 and a protective cover 60. The bracket 20 is fixed to a surface of the circuit board 10. The filter 30 and the lens holder 40 are mounted on the bracket 20. The lens unit 50 is received in the lens holder 40. The protective cover 60 covers the lens unit 50.

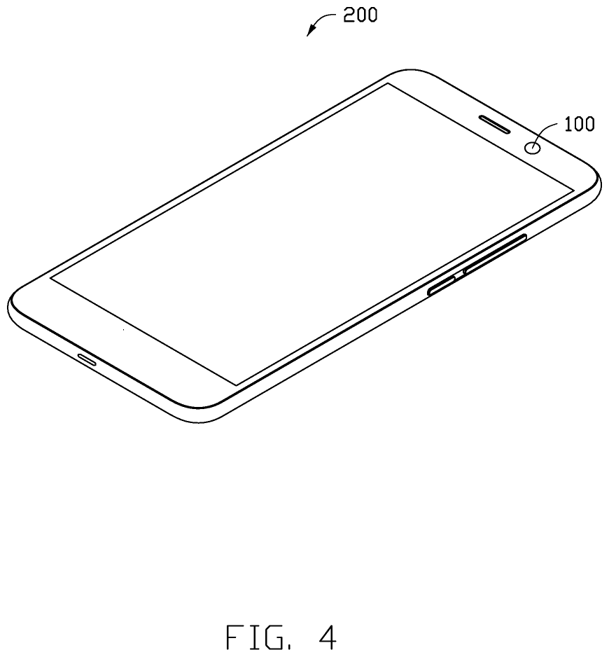

The circuit board 10 can be a ceramic substrate, a soft board, a hard board, or a board combining soft and hard. In the embodiment, the circuit board 10 is a soft and hard board, and includes a first hard board portion 11, a second hard board portion 12, and a soft board portion 13 connected between portions 11 and 12. An electrical connection element 101 is mounted on the second hard board portion 12. The electrical connection element 101 transmits signals between the lens module 100 and other components of an electronic device applying the lens module 100, such as the mobile phone 200 of FIG. 4. The electrical connection element 101 can be a vertical connector or a gold finger connector. In the embodiment, the electrical connection element 101 is a vertical connector.

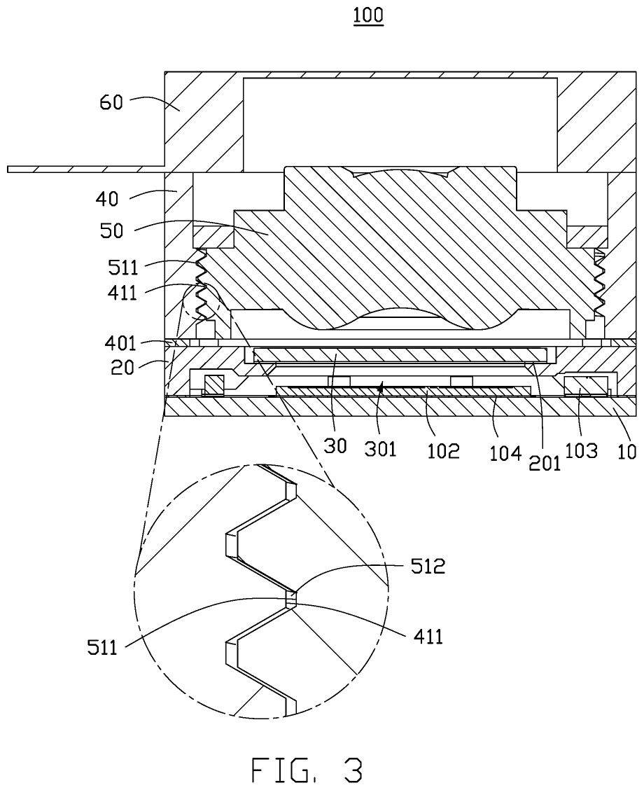

Referring to FIG. 3, the bracket 20 is fixed to one surface of the first hard board portion 11 by a first adhesive layer 201. The bracket 20 is substantially a hollow rectangular structure, and defines a through hole 21 and a recess 22 surrounding the through hole 21.

In the embodiment, the filter 30 is mounted in the recess 22 of the bracket 20 and covers the through hole 21. A receiving room 301 is formed by the circuit board 10, the bracket 20, and the filter 30 for receiving a photosensitive chip 102 and a plurality of electronic components 103. The photosensitive chip 102 is fixed to the first hard board portion 11 by a second adhesive layer 104. The second adhesive layer 104 can be an optical adhesive. In the embodiment, the photosensitive chip 102 is a complementary metal oxide semiconductor (CMOS) chip or a charge coupled device (CCD) chip and is rectangular in shape. The electronic components 103 surround the photosensitive chip 102.

The lens module 100 further includes a reinforcing element 14. The reinforcing element 14 is located on the soft board portion 13 and beside the first hard board portion 11. The reinforcing element 14 is connected to the bracket 20. The reinforcing element 14 reinforces the mechanical strength of the circuit board 10, in particular the soft board portion 13.

The lens holder 40 is fixed to the bracket 20 away from the circuit board 10 by a third adhesive layer 401. The lens holder 40 is a hollow rectangular parallelepiped structure. The lens holder 40 includes a main body 40a defining a receiving hole 41. The main body 40a includes four protruding corner portions 42 surrounding the receiving hole 41. The protruding corner portions 42 increase a wall thickness of the lens holder 40, thereby increasing the robustness and therefore reliability of the lens module 100 as compared to existing cylindrical lens holders. An inner wall 41a of the receiving hole 41 has a first thread 411.

The lens unit 50 includes a first lens portion 51 and a second lens portion 52. In the embodiment, the first lens portion 51 and the second lens portion 52 are integrated. The first lens portion 51 is provided with a second thread 511 on an outer surface 510 of the first lens portion 51. The second thread 511 engages with the first thread 411 to mount the lens unit 50 in the receiving hole 41. A gap 512 exists between the first thread 411 and the second thread 511 when the first thread 411 is engaged with the second thread 511, the gap 512 allows heated and expanded air inside the lens module 100 to escape. The second lens portion 52 has a diameter smaller than a diameter of the first lens portion 551. The first lens portion 51 is received in the receiving hole 41, while the second lens portion 52 is received partially in and partially out of the receiving hole 41.

In the embodiment, the lens module 100 further includes a lens fixing element 53. The lens fixing element 53 is received in the receiving hole 41 and clamped at a junction of the first lens portion 51 and the second lens portion 52, thereby fixing the lens unit 50 and maintaining focus of the lens 50.

The lens module 100 further includes a protective cover 60 disposed on the lens holder 40 away from the bracket 20. The protective cover 60 covers the lens unit 50. The protective cover 60 is removable from the lens unit 50 to expose the lens unit 50.

In the embodiment, the lens unit 50 is detachably assembled to the lens holder 40 by the engaging of the first thread 411 and the second thread 511. Thus fabrication of the lens module 100 can be carried out by different processes such as the LHA process and the AA process. Failure of one element does not require replacement of the entire lens module 100, for example, the lens unit 50 can be independently replaced or repaired if necessary. Furthermore, by adjusting a height of the lens unit 50 relative to the lens holder 40, the lens module 100 can be applied in different applications requiring different heights of lens module 100.

In the embodiment, the reliability of the lens module 100 is improved by adopting a hollow rectangular structure lens holder 40 with protruding corner portions 42, to increase a wall thickness. Furthermore, during working of the lens module 100, the heated and expanded air inside the lens module can escape via a gap 512 between the first thread 411 and the second thread 511, preventing an overpressure in the lens module 100 which could affect image quality.

Referring to FIG. 4, the lens module 100 can be applied to various electronic devices having camera modules, such as mobile phones, wearable devices, computer devices, vehicles, or monitoring devices. In the embodiment, the lens module 100 is applied to a mobile phone 200.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. A lens module comprising a lens holder and a lens unit, wherein the lens holder and the lens unit are detachably assembled, the lens holder defines a receiving hole to receive the lens unit, the receiving hole defines an inner wall formed with a first thread, the lens unit has an outer wall formed with a second thread engaging with the first thread to mount the lens unit in the receiving hole, a gap is defined between the first thread and the second thread to prevent an overpressure in the lens module.

2. The lens module according to claim 1, wherein the lens holder further comprises a plurality of protruding corner portions for increasing a wall thickness of the lens holder.

3. The lens module according to claim 2, wherein the lens holder is a hollow rectangular parallelepiped structure having four protruding corner portions surrounding the receiving hole.

4. The lens module according to claim 1, wherein the lens unit comprises a first lens portion and a second lens portion integrated formed, the second thread is formed on the first lens portion, the first lens portion is received in the receiving hole, and the second lens portion is partially received in and partially out of the receiving hole.

5. The lens module according to claim 4, wherein the lens module further comprises a lens fixing element clamped at a junction of the first lens portion and the second lens portion for fixing the lens unit.

6. An electronic device comprising a lens module, the lens module comprising a lens holder and a lens unit, wherein the lens holder and the lens are detachably assembled, the lens holder defines a receiving hole to receive the lens unit, the receiving hole defines an inner wall formed with a first thread, the lens unit has an outer wall formed with a second thread engaging with the first thread to mount the lens unit in the receiving hole, a gap is defined between the first thread and the second thread to prevent an overpressure in the lens module.

7. The electronic device according to claim 6, wherein the lens holder further comprises a plurality of protruding corner portions for increasing a wall thickness of the lens holder.

8. The electronic device according to claim 7, wherein the lens holder is a hollow rectangular parallelepiped structure having four protruding corner portions surrounding the receiving hole.

9. The electronic device according to claim 6, wherein the lens unit comprises a first lens portion and a second lens portion integrated formed, the second thread is formed on the first lens portion, the first lens portion is received in the receiving hole, and the second lens portion is partially received in and partially out of the receiving hole.

10. The lens module according to claim 9, wherein the lens module further comprises a lens fixing element clamped at a junction of the first lens portion and the second lens portion for fixing the lens unit.
